(19) United States
(12) Patent Application Publication
(10) Pub. No.: US 2005/0245299 A1
(43) Pub. Date: Nov. 3, 2005

(54) Telephone having information window thereon

(75) Inventors: George T. Buehl, West Long Branch, NJ (US); Abraham Zagha, Long Branch, NJ (US)

Correspondence Address: PARKHURST & WENDEL, L.L.P., 1421 PRINCE STREET, SUITE 210, ALEXANDRIA, VA, 22314-2805, US

(73) Assignee: Med-Pat, Inc., Wanamassa, NJ (US)

(21) Appl. No.: 10/834,188

(22) Filed: Apr. 29, 2004

(51) Int. Cl. H04M 1/00

(52) U.S. Cl. 455/575.8; 455/575.1

(57) ABSTRACT

A telephone having a transparent information window on a surface thereof, the window being a transparent cover and the surface supporting the transparent cover adjacent the surface with one edge of the transparent cover being accessible, with an accessible pocket beneath the transparent cover. The surface includes at least one depressed portion adjacent the accessible edge and communicating with the pocket for receiving an initial entry portion of a sheet for bearing information indicia, the length of the accessible edge and the dimensions of the sheet permitting the sheet to be slid entirely beneath the transparent cover.

### FIELD OF THE INVENTION

The present invention comprises a telephone having a large, transparent information window and unique retention lip for the transparent information window.

### BACKGROUND OF THE INVENTION

Telephones having windows for display of a telephone number are known. See generally U.S. Pat. No. 5,416,839 disclosing a one-piece telephone. Such prior windows on telephones are typically small, sufficient to display only one telephone number, usually the number of that telephone line. Sheet media located beneath such small windows typically are sealed or secured beneath the window, and the structural elements attaching such windows to the telephone, such as snap-on attachment points, make quick installation and replacement of information under the window difficult.

### SUMMARY OF THE INVENTION

The telephone of the present invention has a transparent information window thereon that is substantially larger than typical prior windows used for display of only a single number. The window is preferably located on the earpiece/keyboard side of a one-piece telephone, although use on other types of telephone instruments and surfaces is possible. The size of the window is useful for display of a number of emergency or commonly called numbers in a prominent location on the telephone. In addition, advertising, logos or other information can be displayed, together with such numbers.

The window of the present invention facilitates quick insertion while providing secure retention of a printed sheet of information beneath the window.

### BRIEF DESCRIPTION OF THE DRAWINGS

The invention is further explained in conjunction with the following figures illustrating the present invention:

FIG. 1 is a schematic front view of a telephone instrument having a large, transparent information window of the present invention;

FIG. 2 is a schematic side view of the telephone shown in FIG. 1;

FIG. 3A is a schematic sectional view taken along plane 3A-3A of the telephone shown in FIG. 2;

FIG. 3B is a schematic sectional view taken along plane 3B-3B of the telephone shown in FIG. 2;

FIG. 4A is a schematic partial front view of the telephone shown in FIG. 1 with an information sheet at an initial insertion position;

FIG. 4B is a schematic partial front view of the telephone shown in FIG. 1 with an information sheet partially inserted therein;

FIG. 4C is a schematic partial front view of the telephone shown in FIG. 1 with an information sheet completely inserted therein.

### DESCRIPTION OF THE PREFERRED EMBODIMENTS

The subject matter of the present invention is well depicted and described in conjunction with the drawings.

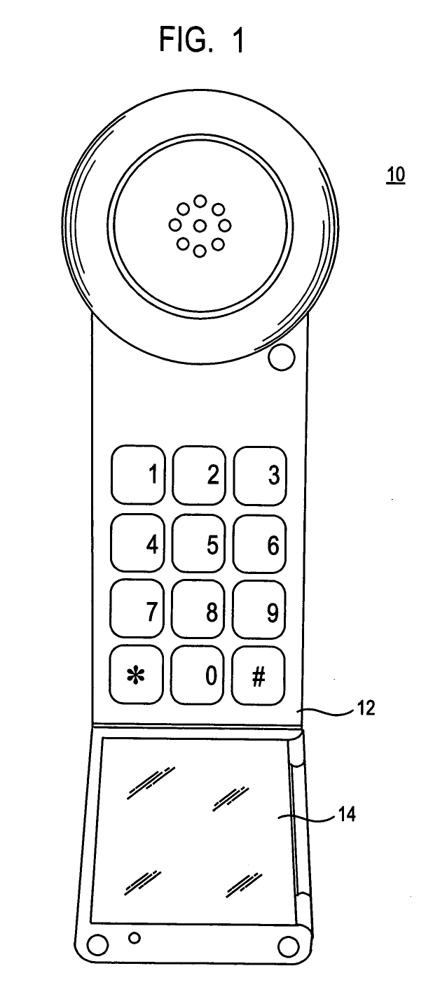

FIG. 1 shows a schematic front view of a telephone 10 including a base 12 and a large, transparent information window 14. Information window 14 may be located on any suitable surface of a telephone receiver/transmitter, cradle or handset, wherein the term “telephone” is understood to include any communication device such as, for example, a cellular telephone, a land line telephone, an intercom, a remote control device, a radio transmitter, or the like.

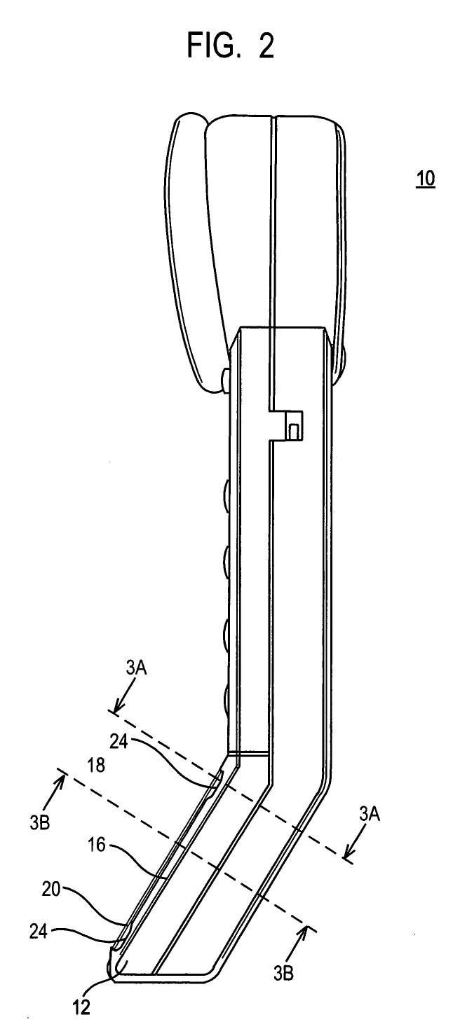

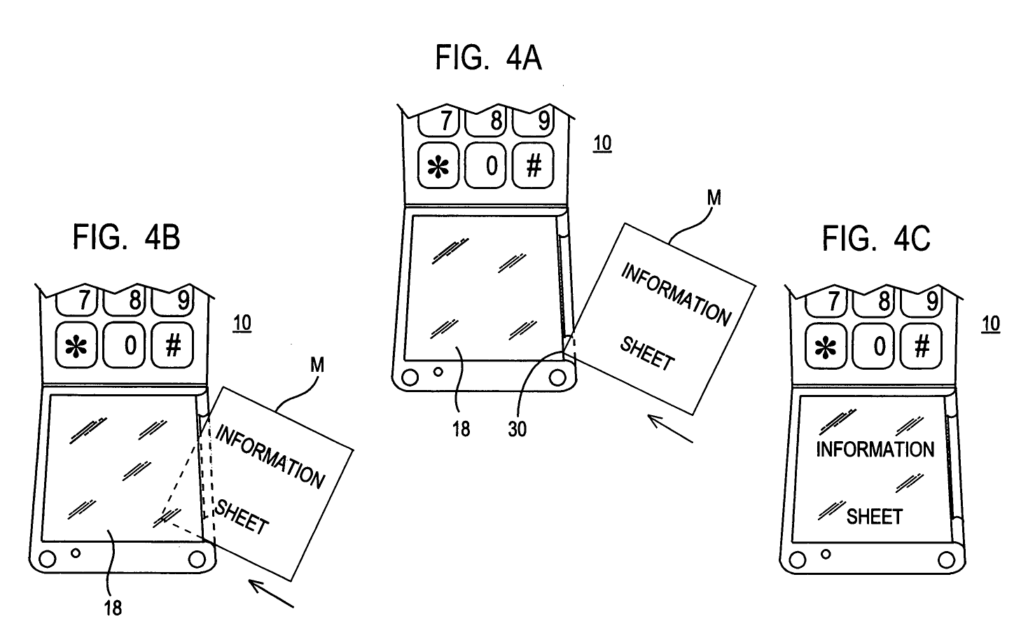

FIG. 2 is a schematic side view of a telephone 10, showing the base 12 including a surface 16 supporting a transparent cover 18 adjacent the surface 16, with one edge 20 of the transparent cover 18 being accessible. Surrounding the transparent cover 18 is a raised lip 28, which retains the transparent cover 18 and a sheet media M (shown in FIGS. 4B and 4C). Also shown are two depressed portions 24, 24 of lip 28 located adjacent accessible edge 20, although one or several depressed portions 24 may be employed depending on the geometry of the base 12.

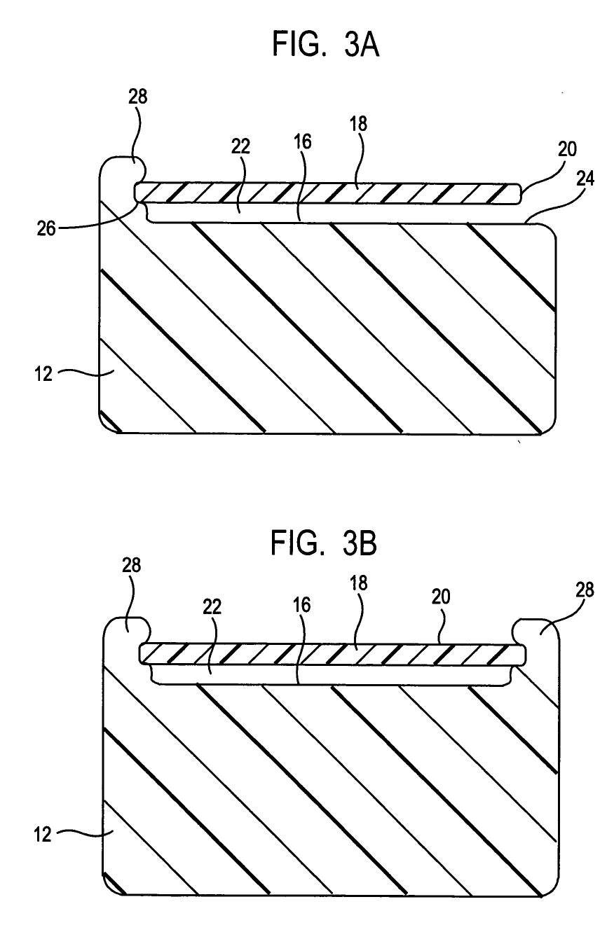

FIG. 3A, in exaggerated large scale for clarity, is a schematic cross-sectional view taken along plane 3A-3A of telephone 10 shown in FIG. 2. Section 3A-3A cuts through base 12 at one of the depressed portions 24, thereby showing transparent cover 18 supported on one side by cover support portion 26, while edge 20 and the space 22 thereunder are accessible on an opposite side, as viewed in FIG. 3. The cover support portion 26 may be located at any edge of cover 18 and may have any suitable shape, such as, for example, a continuous ridge, or a plurality of dimples or protrusions, and can cooperate with similar portions of raised lips 28 to retain and hold an edge of a transparent cover 18. Accessible space or pocket 22 is shown between the transparent cover 18 and the surface 16.

FIG. 3B, also in exaggerated large scale for clarity, is a schematic sectional view taken along plane 3B-3B of telephone 10 shown in FIG. 2, through base 12 at a point other than through one of the depressions 24. The depressed portion 24 shown in FIG. 3A is located on a raised lip 28 portion of surface 16 shown in FIG. 3B, and is adjacent accessible edge 20 of the transparent cover 18. Depressed portion 24 communicates with pocket 22.

FIG. 4A is a schematic partial front view of the telephone 10 shown in FIG. 1, showing the sheet media M in an initial insertion position 30. FIG. 4B is a similar view showing the sheet media M partially inserted beneath the transparent cover 18, wherein the sheet media M entering the accessible pocket 22 passes between the accessible edge 20 of the transparent cover 18 and the adjacent lip 28. FIG. 4C shows the sheet media M completely inserted beneath the transparent cover 18.

1. A telephone having a large information window thereon, comprising:
a window comprising a transparent cover; and
a base comprising a surface supporting the transparent cover adjacent said surface with one edge of the transparent cover being accessible, the transparent cover and base together forming an accessible pocket beneath the transparent cover, wherein the base comprises a raised lip adjacent said accessible edge of the transparent cover for retaining said cover and sheet on the telephone, and at least one depressed portion of the raised lip, said depressed portion communicating with said pocket for receiving an initial entry portion of a sheet for bearing information indicia, the length of said accessible edge and the dimensions of said sheet permitting said sheet to be received entirely beneath said transparent cover.

2. The telephone of claim 1, wherein the transparent cover is rectangular.

3. The telephone of claim 1, wherein said base comprises a cradle for holding a transmitter/receiver handset.

4. The telephone of claim 1, wherein said base comprises a body of a telephone handset.

5. The telephone of claim 1, wherein said base comprises the body of a one-piece telephone, and said transparent cover is located on a surface thereof which includes an earpiece and dial keypad.

6. The telephone of claim 1, wherein said base comprises a body of a cellular telephone.
